(19) United States
(12) Patent Application Publication
(10) Pub. No.: US 2019/0134474 A1
(43) Pub. Date: May 9, 2019

(54) DETACHABLE MOTOR ASSEMBLY FOR GOLF BAG CARRIER

(71) Applicant: Eric Jordan Schneiter, West Point, UT (US)

(72) Inventor: Eric Jordan Schneiter, West Point, UT (US)

(21) Appl. No.: 15/989,013

(22) Filed: May 24, 2018

Related U.S. Application Data
(60) Provisional application No. 62/513,401, filed on May 31, 2017.

(51) Int. Cl. A63B 55/60; B62D 65/10

(52) U.S. Cl. CPC A63B 55/61; B62D 65/10; B62B 5/005; A63B 2225/50; B62B 2202/404; A63B 2055/615

(57) ABSTRACT

Detachable adjustable-width motor assemblies. Some embodiments may be configured for retrofitting between two legs of a golf cart. Some embodiments may comprise a motor housing having a first motor disposed within the motor housing, a first drive shaft, and a second motor disposed within the motor housing having a second drive shaft. The assembly may further comprise a first housing mount configured to be connected to the first wheel leg and a second housing mount configured to be connected to the second wheel leg. The first housing mount and/or the second housing mount may be concentrically and/or slideably engaged with the motor housing and configured to adjust the width of the motor assembly. The first drive shaft may be configured to engage with and transmit torque to the first wheel and the second drive shaft may be configured to engage with and transmit torque to the second wheel.

### RELATED APPLICATIONS

This application claims the benefit under 35 U.S.C. § 119(e) of U.S. Provisional Patent Application No. 62/513,401 filed May 31, 2017 and titled “DETACHABLE MOTOR ASSEMBLY FOR GOLF BAG CARRIER,” which application is incorporated herein by reference in its entirety.

### FIELD OF INVENTION

The present disclosure relates to a motor assembly that can be retrofitted to a standard manually operated golf bag carrier.

### BACKGROUND

Golf bag carriers are commonly used to transport a player's golf clubs and other equipment. Some modern golf bag carriers include motors that are built in and integrated with the golf bag carrier by the manufacturer. More recently, efforts have been made to provide traditional manually operated golf bag carriers with a motor assembly that attaches to one or more wheel stay of the golf cart. For example, U.S. Pat. No. 7,237,632 to Liao discloses a powered mechanism that converts a traditional powerless golf bag carrier into a motorized golf cart. The device of Liao provides a motor assembly with a drive shaft to which the wheels are fixed. The motor assembly is then attached to the wheel stay of the golf cart. This configuration has the limitation that the motor housing cannot be removed from the golf cart without also removing the wheels. Similarly, U.S. Pat. No. 5,839,528 to Lee also discloses a detachable motorized wheel assembly for a golf cart. The device of Lee also fixes the wheels to the motor assembly, preventing use of the wheel without the motor. These above prior art configurations provide limited flexibility to the user.

### SUMMARY OF THE INVENTION

In some embodiments, the present invention provides an improved motor assembly for a golf cart in which the motor assembly is detachable without removing the wheels. This improved configuration may provide the user with flexibility whether to utilize the golf cart with or without motorized power.

In accordance with the following disclosure, in some embodiments the present invention relates to a detachable adjustable-width motor assembly for retrofitting between a first wheel leg having a first wheel and a second wheel leg having a second wheel of a golf bag carrier. The motor assembly may comprise a motor housing, a first motor disposed within the motor housing and having a first drive shaft and a second motor disposed within the motor housing and having a second drive shaft, and a first housing mount configured to be connected to the first wheel leg and a second housing mount configured to be connected to the second wheel leg, wherein one or more of the first housing mount and second housing mount is concentrically and slideably engaged with the motor housing and configured to adjust the width of the motor assembly. The first drive shaft is configured to engage with and transmit torque to the first wheel and the second drive shaft is configured to engage with and transmit torque to the second wheel.

In another embodiment, the first drive shaft is configured to engage with and transmit torque to the first wheel and the second drive shaft is configured to independently engage with and transmit torque to the second wheel.

In another embodiment, the motor assembly includes a first wheel leg mounting adapter configured to connect to the first housing mount and to the first wheel leg, and a second wheel leg mounting adapter configured to connect to the second housing mount and to the second wheel leg. The first drive shaft is configured to extend through the first wheel leg mounting adapter to engage with the first wheel, and the second drive shaft is configured to extend through the second wheel leg mounting adapter to engage with the second wheel.

In another embodiment, the motor assembly may comprise a first secondary drive shaft configured to engage with the first drive shaft and transmit torque to the first wheel, and a second secondary drive shaft configured to engage with the second drive shaft and transmit torque to the second wheel. In some embodiments, the first drive shaft and first secondary drive shaft engage via a first quick release coupling configured to releasably connect the first drive shaft and first secondary drive shaft, and the second drive shaft and second secondary drive shaft engage via a second quick release coupling configured to releasably connect the first drive shaft and first secondary drive shaft. In some embodiments, at least one of the first quick release coupling and second quick release coupling comprises an eccentric male end and a mating eccentric female end.

In some embodiments, the motor assembly further comprises a first quick release connector configured to allow quick connection and release of the first housing mount from the first wheel leg mounting adapter and a second quick release connector configured to allow quick connection and release of the second housing mount from the second wheel leg mounting adapter. In some embodiments, at least one of the first quick release connector and second quick release connector comprises a spring actuated pin on one of the housing mount and wheel leg mounting adapter and detent on the other of the housing mount and wheel leg mounting adapter positioned to receive the spring actuated pin.

In some embodiments, the first drive shaft is connected to the first wheel via a first wheel cog adapter, and wherein the second drive shaft is connected to the second wheel via a second wheel cog adapter. In some embodiments, the first wheel cog adapter comprises splines that engage with mating splines on an inner surface of the first wheel, wherein the second wheel cog adapter comprises splines that engage with mating splines on an inner surface of the second wheel.

In some embodiments, the motor assembly further comprises a power source and a control unit configured to control the first and second motors. In some embodiments, the control unit comprises a wireless transmitter that is controllable with a remote-control device.

In another aspect, the present invention relates to methods for retrofitting a wheeled golf bag carrier with a detachable motor assembly, wherein the golf bag carrier has a first wheel leg having a first wheel and second wheel leg having a second wheel of a golf bag carrier. The steps of such a method may include removing the wheels from the golf bag carrier wheel mounting brackets, attaching to the first wheel leg a first wheel leg mounting adapter having an axle housing, and attaching to the second wheel leg a second wheel leg mounting adapter having an axle housing, inserting a first secondary drive shaft through the axle housing of the first wheel leg mounting adapter and connecting the secondary drive shaft to the first wheel, and inserting a second secondary drive shaft through the axle housing of the second wheel leg mounting adapter and connecting the second secondary drive shaft to the second wheel, and connecting between the first wheel leg mounting adapter and second wheel leg mounting adapter a detachable motor assembly. The detachable motor assembly comprises a motor housing, a first motor disposed within the motor housing and having a first drive shaft and a second motor disposed within the motor housing and having a second drive shaft, a first housing mount configured to be connected to the first wheel leg mounting adapter and a second housing mount configured to be connected to the second wheel leg mounting adapter, wherein one or more of the first housing mount and second housing mount is concentrically and slideably engaged with the motor housing and configured to adjust the width of the motor assembly. The first drive shaft is configured to engage with and transmit torque to the first secondary drive shaft and first wheel and the second drive shaft is configured to engage with and transmit torque to the second secondary drive shaft and second wheel.

These and other aspects of the present invention are shown and described in the following figures and related description.

### DRAWINGS

FIG. 1 shows a rear view of a detachable motor assembly, as attached to the left and right legs of a golf bag carrier.

FIG. 2 shows a perspective view of FIG. 1.

FIG. 3 shows an exploded perspective view of a detachable motor assembly.

FIG. 4 shows an exploded view of a detachable motor assembly.

FIG. 5 shows a cross-sectional view of a detachable motor assembly.

FIG. 6 shows an exploded perspective view of the drive shaft components of a detachable motor assembly, from a left perspective.

FIG. 7 shows an exploded perspective view of the drive shaft components of a detachable motor assembly, from a right perspective.

FIG. 8 shows a detachable motor assembly, as connected to a power supply and control system.

### DETAILED DESCRIPTION

The skilled artisan will understand that the claimed device described below can be practiced without employing these specific details, or that they can be used for purposes other than those described herein. Indeed, they can be modified and can be used in conjunction with products and techniques known to those of skill in the art in light of the present disclosure.

Reference in the specification to “one configuration,” “one embodiment” “one aspect” or “a configuration,” “an embodiment” or “an aspect” means that a particular feature, structure, or characteristic described in connection with the configuration may be included in at least one configuration and not that any particular configuration is required to have a particular feature, structure or characteristic described herein unless set forth in the claim. The appearances of the phrase “in one configuration” or similar phrases in various places in the specification are not necessarily all referring to the same configuration, and may not necessarily limit the inclusion of a particular element of the invention to a single configuration, rather the element may be included in other or all configurations discussed herein. Thus, it will be appreciated that the claims are not intended to be limited by the representative configurations shown herein. Rather, the various representative configurations are simply provided to help one of ordinary skill in the art to practice the inventive concepts claimed herein.

Furthermore, the described features, structures, or characteristics of embodiments of the present disclosure may be combined in any suitable manner in one or more embodiments. In the following description, numerous specific details may be provided, such as examples of devices, structures or manufacturing methods that may be used, to provide a thorough understanding of embodiments of the invention. One skilled in the relevant art will recognize, however, that embodiments discussed in the disclosure may be practiced without one or more of the specific details, or with other methods, compounds, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience.

However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The invention and will now be so as to enable one skilled in the art to practice the present invention. The descriptions are intended to be exemplary of various aspects of the invention and are not intended to narrow the scope of the appended claims.

The present invention provides an improved detachable motor assembly for a golf bag carrier, which allows the motor assembly to be removed from the golf bag carrier without concomitantly removing the wheels.

Golf bag carriers are typically configured with three wheels, two rear wheels and a single front wheel, for stability on uneven surfaces. The two rear wheels are typically each attached to a wheel stay, such as a light weight tube, that extends from the frame of the golf bag carrier (to which the user's golf bag is attached) down to the wheel. The third wheel is generally attached to a front portion of the golf bag carrier. The golf bag carrier is then able to roll on the three wheels.

In some embodiments, the detachable adjustable-width motor assembly of the present invention is configured to mount between two wheels of a golf bag carrier, such as between the two rear wheels of a standard powerless golf bag carrier, by narrowing the width of the motor assembly to fit between the two legs, and then expanding the width to engage with the two wheels on either side.

In one particular embodiment, the detachable adjustable-width motor assembly comprises a motor housing within which is positioned a first motor configured to drive a first drive shaft and a second motor configured to drive a second drive shaft. The first motor and second motor are each disposed within the housing. In order to transmit torque from the motor to the wheels of the golf bag carrier, the motors directly or indirectly fixed to the motor housing, and the other components of the motor assembly are fixed to the golf bag carrier (e.g., to the wheel legs) such that axial rotation of the drive shaft turns the wheels relative to the golf bag carrier. Thus, in some embodiments, the motor assembly may also comprise a first housing mount configured to be connected to the first wheel leg of the golf cart and a second housing mount configured to be connected to the second wheel leg of the golf cart.

In accordance with one embodiment, one or more of the first housing mount and second housing mount is concentrically and slideably engaged with the motor housing and configured to adjust the width of the motor housing. Since the motor assembly is narrowed to fit between the wheels of the golf cart, and then be expanded to engage with the wheels of the golf cart, in some embodiments only one of the first and second housing mount is concentrically and slideably engaged with the motor housing, while the other is fixed to the housing. Alternatively, in a different embodiment, both the first and second housing mounts may be concentrically and slideably engaged with the motor housing, such that both ends of the motor assembly can slide in and out of the motor housing.

In one embodiment, the motor housing may comprise an outer sleeve and the first and second housing mounts may be disposed within the motor housing outer sleeve. In other embodiments, the motor housing may comprise an inner sleeve, while the first and second housing mounts are configured to concentrically slide on the outside of the motor housing.

The length of the motor housing is determined by and may be adjusted to accommodate the width of the distance between the two wheels between which the motor housing is placed. Specifically, the width of the motor housing should be narrow enough that when the first and/or second housing mounts completely slide into the motor housing there is sufficient clearance for the ends of the motor housing assembly to fit between the two wheels of the golf cart. The motor housing can then be expanded so that the drive shafts connected to the motors engage with the two wheels. The first drive shaft is configured to be engaged with and transmit torque to the first wheel and the second drive shaft is configured to independently be engaged with and transmit torque to the second wheel.

In another aspect, the present invention provides mounting adapters that are configured to mount the motor assembly to the wheel legs. The mounting adapters connect directly to the housing mounts that slideably engage with the motor housing. The mounting adapters also connect directly to the wheel legs or to a bracket at the end of the wheel legs that is part of the original equipment of the golf bag carrier. For example, in one embodiment, the motor assembly may further comprise a first wheel leg mounting adapter that is configured to connect to the first housing mount and also configured to connect to the first wheel leg. The motor assembly may also comprise a second wheel leg mounting adapter that is configured to connect to the second housing mount and also configured to connect to the second wheel leg. The mounting adapter may be configured to specifically fit the dimensions of the wheel bracket of a particular brand of golf bag carrier (from which the wheels have been removed). For example, where an OEM wheel bracket may have a lumen through which a wheel axle extended, the mounting adapter may have a shape that mates with and fits over the original wheel bracket and include a cotter pin, spring loaded pin, or any other suitable mechanism for attaching the wheel leg mounting adapter to the original wheel bracket.

In another aspect, the present invention may also include quick release connectors between the housing mounts and the wheel leg mounting adapters to secure the motor housing/housing mount to the wheel leg of the golf bag carrier. The quick release connects may be any suitable mechanical quick release mechanism, such as a cotter pin, spring loaded pin that fits into a pin hole or detent in the opposing structure, screw type clamp, etc.

The wheel leg mounting adapter also functions to support the golf bag carrier wheel. The wheel leg mounting adapter includes an axle lumen through which a secondary drive shaft connected to a wheel is disposed. The first drive shaft is configured to extend through the axle lumen of the first adapter and engage with the first wheel, and the second drive shaft is configured to extend through the axle lumen of the second mounting bracket and engage with the second wheel.

In another aspect, the present invention provides a secondary drive shaft connected to each of the two wheels of the golf bag carrier between which the motor assembly is placed. In one embodiment, the motor assembly may include a first secondary drive shaft that is configured to releasably engage with the first wheel, and a second secondary drive shaft that is configured to engage with the second wheel. The first secondary drive shaft is configured to releasably engage with the first drive shaft and the second secondary drive shaft is configured to engage with the second drive shaft. The primary drive shaft connected to the motor and secondary drive shaft connected to the wheel are configured to mate together with a releasable coupling. For example, one of the first drive shaft and first secondary drive shaft may have an eccentric male end and the other has a matching eccentric female end, and one of the second drive shaft and second secondary drive shaft has an eccentric male end and the other has a matching eccentric female end. For example, the primary drive shaft may have a male hex head on its end, while the secondary drive shaft may have a female hex shaped lumen that matches the male hex head of the primary drive shaft. The primary and secondary drive shafts can easily be separated from each other by sliding the hex end out of the hex lumen. In another embodiment, the first drive shaft connected to the first motor is connected to the first wheel by a secondary drive shaft that is connected to first wheel, wherein the first drive shaft and the secondary drive shaft are connected by a releasable splined connection that is configured to transmit radial torque from the first drive shaft to the secondary drive shaft and can be disconnected by separating the first drive shaft and the secondary drive shaft in an axial direction, and wherein the second drive shaft connected to the second motor is connected to the second wheel by a secondary drive shaft that is connected to second wheel, wherein the second drive shaft and the secondary drive shaft are connected by a releasable splined connection that is configured to transmit radial torque from the second drive shaft to the secondary drive shaft and can be disconnected by separating the second drive shaft and the secondary drive shaft in an axial direction. The eccentric shape of the drive shaft coupling enables the primary drive shaft to transmit torque to the secondary drive shaft and thereby turn the wheels of the golf bag carrier. It is understood that the primary and secondary shafts may be coupled using alternative eccentric shapes, such as a square shape, star shape, flatted shaft side, or splines.

In another aspect, the present invention provides wheel cog adapters that are configured to connect to the secondary draft shaft and that can be force fitted to the inside geometry of the OEM wheels. For example, where the inside geometry of the OEM wheels comprises a series of splines, the wheel cog adapter may have a mating geometry that can be force fitted within or around the splines of the OEM wheel. In a particular embodiment, the first drive shaft is connected to the first wheel via a first wheel cog adapter, wherein the first wheel cog adapter comprises splines that mate with splines on an inner surface of the first wheel, wherein the second drive shaft is connected to the second wheel via a second wheel cog adapter, wherein the second wheel cog adapter comprises splines that mate with splines on an inner surface of the second wheel. It is understood that other inside wheel surface geometries are possible that the particular geometry of the wheel cog adapters will match or mate with the geometry of the wheel surface. In the event that the inside wheel surface geometry of the OEM wheels is smooth and cannot be mated with a wheel cog adapter, replacement wheels may be provided by the manufacturer of the detachable adjustable-width motor assembly described herein.

In another embodiment, the motor assembly of the present invention may further include a power source, such as a battery, and a control unit configured to control the first and second motors. Control of the first and second motor not only provides power to the wheels to cause forward or reverse movement of the golf bag carrier, but also can change the direction of movement of the golf bag carrier by providing more power or speed to one wheel relative to the other wheel. In another embodiment, the control unit comprises a wireless transmitter that is controllable with a remote-control device.

In another aspect, the present invention includes methods for retrofitting a wheeled golf bag carrier with a detachable motor assembly, wherein the golf bag carrier has a first wheel leg having a first wheel and second wheel leg having a second wheel of a golf bag carrier. In one embodiment, the methods comprise the steps of removing the wheels from the golf bag carrier wheel mounting brackets, attaching to the first wheel leg a first wheel leg mounting adapter having an axle housing, and attaching to the second wheel leg a second wheel leg mounting adapter having an axle housing, inserting a first secondary drive shaft through the axle housing of the first wheel leg mounting adapter and connecting the secondary drive shaft to the first wheel, and inserting a second secondary drive shaft through the axle housing of the second wheel leg mounting adapter and connecting the second secondary drive shaft to the second wheel, and connecting between the first wheel leg mounting adapter and second wheel leg mounting adapter a detachable motor assembly. In one embodiment, the detachable motor assembly comprises a motor housing, a first motor disposed within the motor housing and having a first drive shaft and a second motor disposed within the motor housing and having a second drive shaft, a first housing mount configured to be connected to the first wheel leg mounting adapter and a second housing mount configured to be connected to the second wheel leg mounting adapter, wherein one or more of the first housing mount and second housing mount is concentrically and slideably engaged with the motor housing and configured to adjust the width of the motor assembly. The first drive shaft is configured to engage with and transmit torque to the first secondary drive shaft and first wheel and the second drive shaft is configured to engage with and transmit torque to the second secondary drive shaft and second wheel.

As described above, in some embodiments the first drive shaft is configured to engage with and transmit torque to the first wheel and the second drive shaft is configured to independently engage with and transmit torque to the second wheel. In other embodiments, the first drive shaft and first secondary drive shaft engage via a first quick release coupling configured to releasably connect the first drive shaft and first secondary drive shaft, and the second drive shaft and second secondary drive shaft engage via a second quick release coupling configured to releasably connect the first drive shaft and first secondary drive shaft.

In yet other embodiments, at least one of the first quick release coupling and second quick release coupling comprises an eccentric male end and a mating eccentric female end.

In still other embodiments, the motor assembly further comprises a first quick release connector configured to allow quick connection and release of the first housing mount from the first wheel leg mounting adapter and a second quick release connector configured to allow quick connection and release of the second housing mount from the second wheel leg mounting adapter. In some embodiments, at least one of the first quick release connector and second quick release connector comprises a spring actuated pin on one of the housing mount and wheel leg mounting adapter and detent on the other of the housing mount and wheel leg mounting adapter positioned to receive the spring actuated pin.

In some embodiments, the first drive shaft is connected to the first wheel via a first wheel cog adapter, and wherein the second drive shaft is connected to the second wheel via a second wheel cog adapter.

In other embodiments, the first wheel cog adapter comprises splines that engage with mating splines on an inner surface of the first wheel, wherein the second wheel cog adapter comprises splines that engage with mating splines on an inner surface of the second wheel.

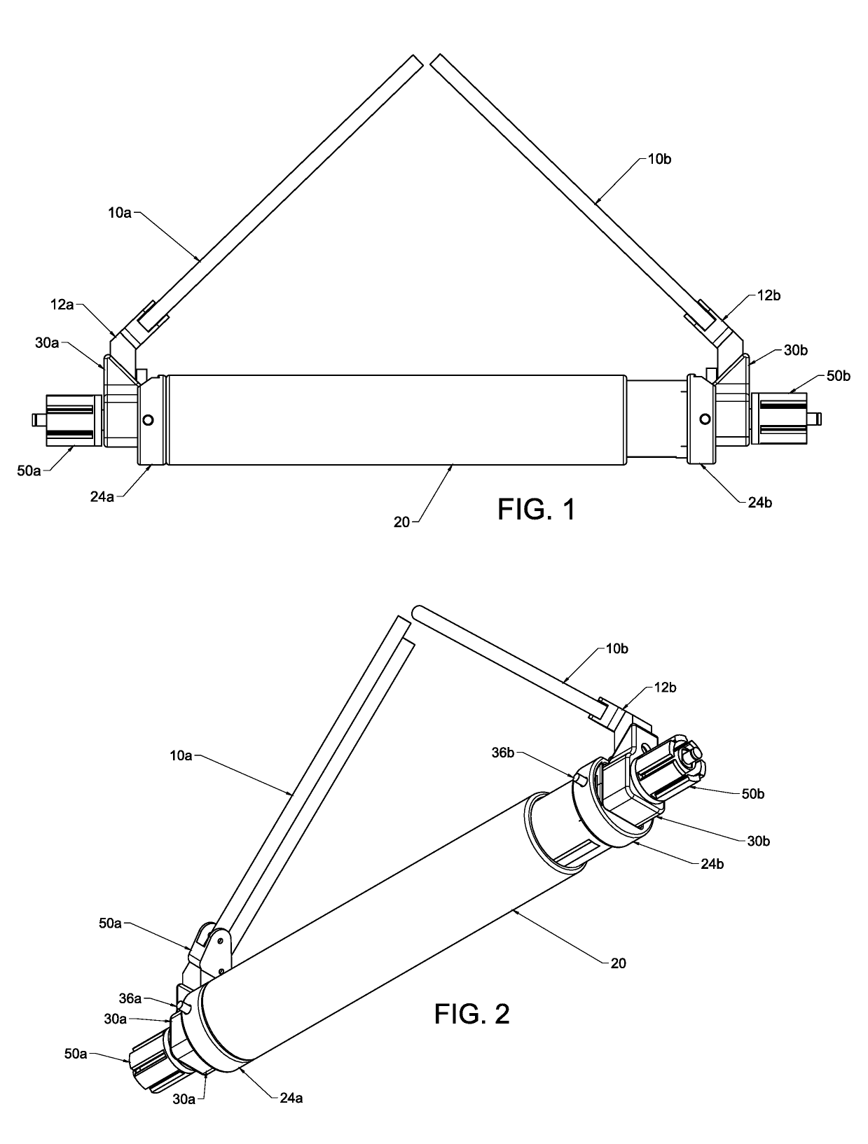

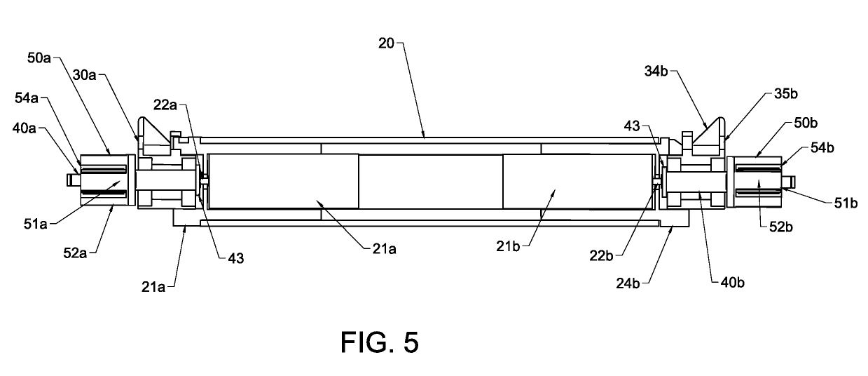

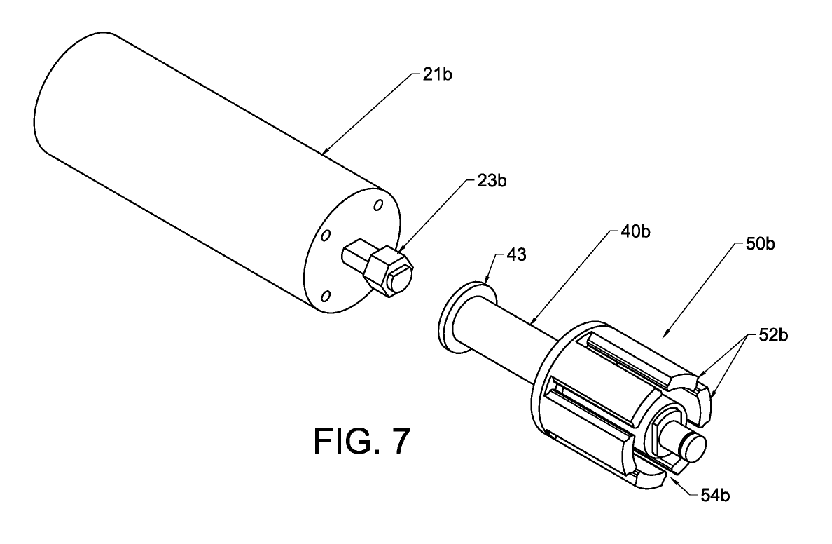

One particular embodiment of the present invention is shown in the attached FIGS. 1-7. It is understood that the embodiments shown in the drawings are merely exemplary and are not intended to limit the scope of the claims. Alternative embodiments and constructions not shown in the drawings are contemplated to fall within the scope of the claims and would be within the ordinary skill in the art.

Referring to the drawings, FIGS. 1 and 2 show a detachable adjustable-width motor assembly comprising a motor housing 20 within which is positioned a first motor (not shown) configured to transmit torque to wheel cog 40a and a second motor configured to transmit torque to the wheel cog 40b. Wheel cogs 40a and 40b are attached to the inside surface of the wheels. The motors inside the motor housing 20 transmit torque via drive shafts that extend through the housing mounts 24a, 24b, wheel leg mounting adapters 30a, 30b. The drive shafts include a primary drive shaft (not shown) directly connected to a motor, which engages with a secondary drive shaft (not shown) that is connected to the wheel cog adapters 40a, 40b that are connected to the wheels (not shown). FIGS. 1 and 2 also show the wheel leg mounting adapters 30a, 30b connected to OEM leg brackets 12a and 12b fixed to golf bag carrier wheel legs 10a, 10b.

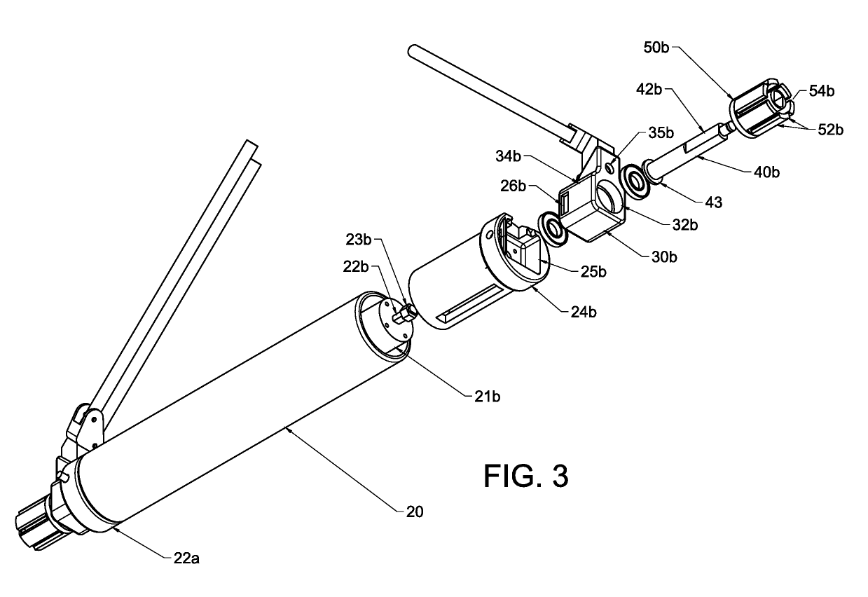

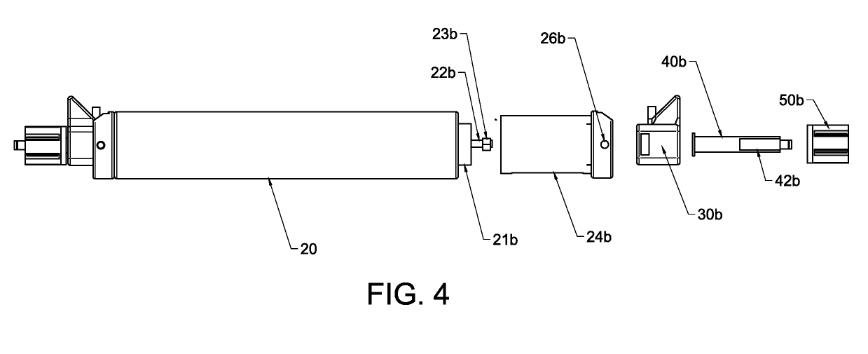

FIGS. 3 and 4 provide additional details of one embodiment of the motor assembly of the present invention. For simplicity, FIGS. 3 and 4 show the left end of the motor assembly connected together, and the right end expanded apart. It is understood that the components of the expanded end shown in FIGS. 3 and 4 also represent similar components for the other end of the motor assembly, except where specifically indicated otherwise. As shown in FIGS. 3 and 4, motor 21b is disposed within the housing 20. In order to transmit torque from the motor 20 to the wheels of the golf bag carrier, the motors are directly or indirectly fixed to the motor housing or are at least radially fixed relative to the housing so that power to the motor does not cause the motor to rotate radially relative to the housing. The other components of the motor assembly are fixed to the golf bag carrier (e.g., to the wheel legs) such that axial rotation of the drive shaft 22b (connected to the secondary drive shaft 40b via a hexagonally shaped drive shaft connector 23b) turns the secondary drive shaft 40b, the wheel cog adapter 50b, and then the wheels relative to the golf bag carrier. The motor assembly also includes a housing mount 24b that is configured to be connected to a wheel leg or wheel leg adapter of the golf bag carrier.

The housing mount 24b is concentrically and slideably engaged with the motor housing 20 and configured to adjust the width of the motor housing, which allows the motor assembly to be narrowed to fit between the wheels of the golf cart, and then be expanded to engage with the wheels of the golf cart. As shown in FIG. 3, the motor housing 20 is in the shape of an outer sleeve and the housing mount 24b is disposed within the motor housing outer sleeve.

The motor assembly shown in FIGS. 3 and 4 also show a wheel leg mounting adapter 30b that fits within mounting space 25b and connects to the housing mount 24b of the motor assembly via a quick release spring loaded pin 36b that fits within and locks into pin hole or detent 26b of the housing mount. The wheel leg mounting adapter 30b provides support for the secondary drive shaft 40b that fits through the axle housing 32b through the mounting adapter and connects to the wheel cog adapter 50b.

The wheel leg mounting adapter 30b is also configured to connect to a wheel leg via mounting structure 34b, which is designed to fit the dimensions of the OEM wheel bracket of a particular brand of golf bag carrier (from which the wheels have been removed). The mounting structure 34b is shown with an aperture 32b for the axle, which corresponds with the axle aperture of an OEM wheel bracket. When mounting structure 34b is fitted to the OEM wheel bracket, a pin can be inserted through aperture 35b and the through the axle aperture of the OEM wheel bracket to secure the wheel leg mounting adapter 30b to the wheel leg.

The wheel leg mounting adapter 30b further supports a secondary drive shaft 40b, which connects to wheel cog adapter 50b. The secondary drive shaft 40b is inserted through axle aperture 32b from the housing mount side. Flange 43 prevents the secondary drive shaft from sliding all the way through the axle aperture 32b. The secondary drive shaft 40b further includes a flatted side 42b, which mates with the internal lumen 51b (also having a flatted internal side) of wheel cog adapter 50b, so as to transmit torque from the secondary drive shaft to the wheel cog adapter connected to the wheel.

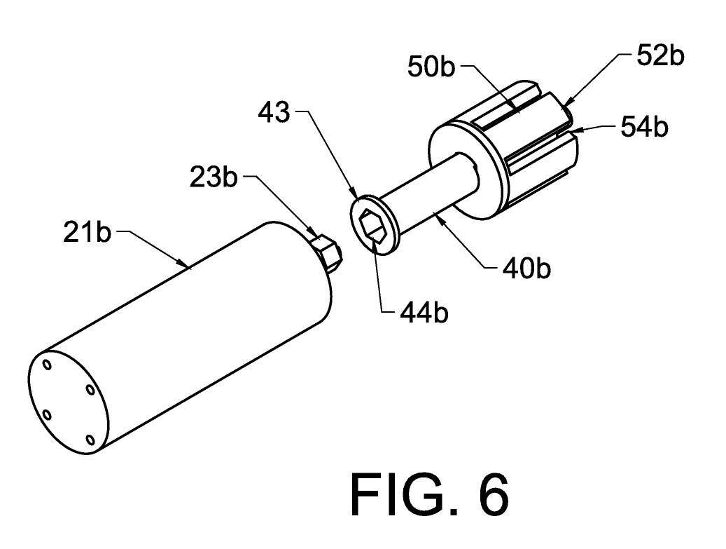

As shown in FIG. 6, a male hex-shaped drive shaft connector 23b is fitted inside a female hex-shaped lumen 44b to releasably connect the primary drive shaft 22b and the secondary drive shaft 40b.

As shown in FIGS. 3 and 4, wheel cog adapter 50b has a plurality of splines 52b, with spaces 54b, which mate with and are force fitted to the inside surface of an OEM wheel hub (not shown). The particular shape and configuration of the splines and spaces will vary, depending on the corresponding shape of the inside surface of the wheels.

In another aspect, the present invention also provides a detachable adjustable-width motor assembly having control system for operating the motors. The control system may include, for example, a power source, such as a battery, and a control unit configured to control the first and second motors. Control of the first and second motor not only provides power to the wheels to cause forward or reverse movement of the golf bag carrier, but also can change the direction of movement of the golf bag carrier by providing more power or speed to one wheel relative to the other wheel. In another embodiment, the control unit comprises a wireless transmitter that is controllable with a remote-control device.

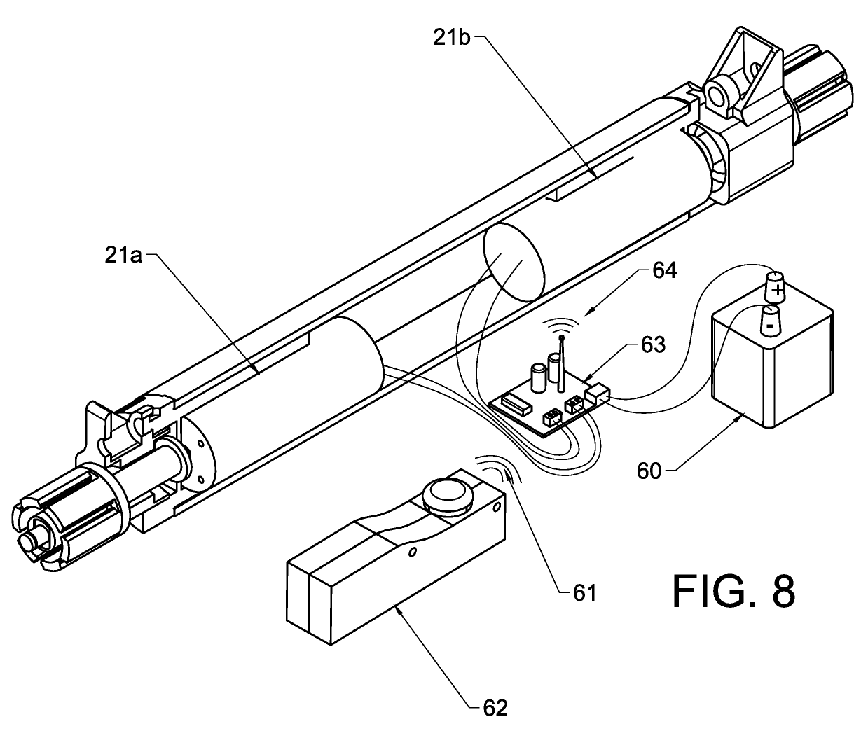

FIG. 8 shows one particular embodiment of a control system configured to control the first and second motors 21a and 22b. The control system includes a control unit 63, powered by a power source 60, which delivers electrical signals and power to the motors 21a and 21b. The control unit is operably connected to and receives instructions from an input device 62 that may include such controls as an on/off switch, speed control switch that controls the speed of the golf bag carrier, and directional control switch that control the direction of travel of the golf bag carrier. The input device 62 may be operably connected to the control unit 63 via wires or wirelessly. FIG. 8 shows a wireless configuration, wherein the control unit 63 includes a wireless receiver 64 which receives data sent from a wireless transmitter 61 in a remote-controlled input device 62. The wireless communication between the input device 62 and the control unit 63 may be by any suitable wireless technology capable of exchanging data, such as radio signals, infrared signals, or Bluetooth. It is understood that the input device 62 may be in the form of a hand-held device, such as a dedicated input device that includes a dedicated control buttons or wheels (i.e., for steering), or alternatively a smart-phone having an application that allows the user to control the golf cart using touch screen controls.

It will be appreciated that numerous modifications may be made without departing from the scope and spirit of this disclosure. The appended claims are intended to cover such modifications.

1. A detachable adjustable-width motor assembly for retrofitting between a first wheel leg having a first wheel and a second wheel leg having a second wheel of a golf bag carrier, comprising:
a motor housing;
a first motor disposed within the motor housing and having a first drive shaft and a second motor disposed within the motor housing and having a second drive shaft;
a first housing mount configured to be connected to the first wheel leg and a second housing mount configured to be connected to the second wheel leg, wherein one or more of the first housing mount and second housing mount is concentrically and slideably engaged with the motor housing and configured to adjust the width of the motor assembly; and
wherein the first drive shaft is configured to engage with and transmit torque to the first wheel and the second drive shaft is configured to engage with and transmit torque to the second wheel.

2. The detachable adjustable-width motor assembly according to claim 1, wherein the first drive shaft is configured to engage with and transmit torque to the first wheel and the second drive shaft is configured to independently engage with and transmit torque to the second wheel.

3. The detachable adjustable-width motor assembly according to claim 1, further comprising:
a first wheel leg mounting adapter configured to connect to the first housing mount and to the first wheel leg, and a second wheel leg mounting adapter configured to connect to the second housing mount and to the second wheel leg;
wherein the first drive shaft is configured to extend through the first wheel leg mounting adapter to engage with the first wheel, and the second drive shaft is configured to extend through the second wheel leg mounting adapter to engage with the second wheel.

4. The detachable adjustable-width motor assembly according to claim 3, further comprising a first secondary drive shaft configured to engage with the first drive shaft and transmit torque to the first wheel, and a second secondary drive shaft configured to engage with the second drive shaft and transmit torque to the second wheel.

5. The detachable adjustable-width motor assembly according to claim 4, wherein the first drive shaft and first secondary drive shaft engage via a first quick release coupling configured to releasably connect the first drive shaft and first secondary drive shaft, and the second drive shaft and second secondary drive shaft engage via a second quick release coupling configured to releasably connect the first drive shaft and first secondary drive shaft.

6. The detachable adjustable-width motor assembly according to claim 5, wherein at least one of the first quick release coupling and second quick release coupling comprises an eccentric male end and a mating eccentric female end.

7. The detachable adjustable-width motor assembly according to claim 3, wherein the motor assembly further comprises a first quick release connector configured to allow quick connection and release of the first housing mount from the first wheel leg mounting adapter and a second quick release connector configured to allow quick connection and release of the second housing mount from the second wheel leg mounting adapter.

8. The detachable adjustable-width motor assembly according to claim 7, wherein at least one of the first quick release connector and second quick release connector comprises a spring actuated pin on one of the housing mount and wheel leg mounting adapter and detent on the other of the housing mount and wheel leg mounting adapter positioned to receive the spring actuated pin.

9. The detachable adjustable-width motor assembly according to claim 1, wherein the first drive shaft is connected to the first wheel via a first wheel cog adapter, and wherein the second drive shaft is connected to the second wheel via a second wheel cog adapter.

10. The detachable adjustable-width motor assembly according to claim 1, wherein the first wheel cog adapter comprises splines that engage with mating splines on an inner surface of the first wheel, wherein the second wheel cog adapter comprises splines that engage with mating splines on an inner surface of the second wheel.

11. The detachable adjustable-width motor assembly according to claim 1, wherein the first drive shaft connected to the first motor is connected to the first wheel by a first secondary drive shaft that is connected to first wheel, wherein the first drive shaft and the secondary drive shaft are connected by a releasable splined connection that is configured to transmit radial torque from the first drive shaft to the secondary drive shaft and can be disconnected by separating the first drive shaft and the secondary drive shaft in an axial direction, and wherein the second drive shaft connected to the second motor is connected to the second wheel by a second secondary drive shaft that is connected to second wheel, wherein the second drive shaft and the secondary drive shaft are connected by a releasable splined connection that is configured to transmit radial torque from the second drive shaft to the secondary drive shaft and can be disconnected by separating the second drive shaft and the secondary drive shaft in an axial direction.

12. The detachable adjustable-width motor assembly according to claim 1, further comprising a control system having a power source and a control unit configured to control the first and second motors.

13. The detachable adjustable-width motor assembly according to claim 9, wherein the control system comprises a wireless transmitter that is controllable with a remote-control input device.

14. A method for retrofitting a wheeled golf bag carrier with a detachable motor assembly, wherein the golf bag carrier has a first wheel leg having a first wheel and second wheel leg having a second wheel of a golf bag carrier:
(a) removing the wheels from the golf bag carrier wheel mounting brackets;
(b) attaching to the first wheel leg a first wheel leg mounting adapter having an axle housing, and attaching to the second wheel leg a second wheel leg mounting adapter having an axle housing;
(c) inserting a first secondary drive shaft through the axle housing of the first wheel leg mounting adapter and connecting the secondary drive shaft to the first wheel, and inserting a second secondary drive shaft through the axle housing of the second wheel leg mounting adapter and connecting the second secondary drive shaft to the second wheel;
(d) connecting between the first wheel leg mounting adapter and second wheel leg mounting adapter a detachable motor assembly, wherein the detachable motor assembly comprises:
a motor housing;
a first motor disposed within the motor housing and having a first drive shaft and a second motor disposed within the motor housing and having a second drive shaft;
a first housing mount configured to be connected to the first wheel leg mounting adapter and a second housing mount configured to be connected to the second wheel leg mounting adapter, wherein one or more of the first housing mount and second housing mount is concentrically and slideably engaged with the motor housing and configured to adjust the width of the motor assembly; and
wherein the first drive shaft is configured to engage with and transmit torque to the first secondary drive shaft and first wheel and the second drive shaft is configured to engage with and transmit torque to the second secondary drive shaft and second wheel.

15. The method according to claim 14, wherein the first drive shaft is configured to engage with and transmit torque to the first wheel and the second drive shaft is configured to independently engage with and transmit torque to the second wheel.

16. The method according to claim 14, wherein the first drive shaft and first secondary drive shaft engage via a first quick release coupling configured to releasably connect the first drive shaft and first secondary drive shaft, and the second drive shaft and second secondary drive shaft engage via a second quick release coupling configured to releasably connect the first drive shaft and first secondary drive shaft.

17. The method according to claim 16, wherein at least one of the first quick release coupling and second quick release coupling comprises an eccentric male end and a mating eccentric female end.

18. The method according to claim 16, wherein the motor assembly further comprises a first quick release connector configured to allow quick connection and release of the first housing mount from the first wheel leg mounting adapter and a second quick release connector configured to allow quick connection and release of the second housing mount from the second wheel leg mounting adapter.

19. The method according to claim 18, wherein at least one of the first quick release connector and second quick release connector comprises a spring actuated pin on one of the housing mount and wheel leg mounting adapter and detent on the other of the housing mount and wheel leg mounting adapter positioned to receive the spring actuated pin.

20. The method according to claim 14, wherein the first drive shaft is connected to the first wheel via a first wheel cog adapter, and wherein the second drive shaft is connected to the second wheel via a second wheel cog adapter.

21. The method according to claim 20, wherein the first wheel cog adapter comprises splines that engage with mating splines on an inner surface of the first wheel, wherein the second wheel cog adapter comprises splines that engage with mating splines on an inner surface of the second wheel.
